(19) United States
(12) Patent Application Publication
(10) Pub. No.: US 2014/0168171 A1
(43) Pub. Date: Jun. 19, 2014

(54) TOUCH SENSING DEVICE AND TOUCH SENSING METHOD

(71) Applicant: SAMSUNG ELECTRO-MECHANICS CO., LTD., Suwon (KR)

(72) Inventors: Yoon Seok OH, Suwon (KR); Ji Hoon KIM, Suwon (KR); Sang Hyun SIM, Suwon (KR); Bo Yle SEO, Suwon (KR)

(73) Assignee: SAMSUNG ELECTRO-MECHANICS CO., LTD., Suwon (KR)

(21) Appl. No.: 13/772,496

(22) Filed: Feb. 21, 2013

(30) Foreign Application Priority Data
Dec. 13, 2012 (KR) 10-2012-0145566

(51) Int. Cl. G06F 3/044

(52) U.S. Cl. CPC G06F 3/044
USPC 345/178

(57) ABSTRACT

There are provided a touch sensing device and a touch sensing method, the touch sensing device including a sensing circuit unit detecting a plurality of changes in capacitance generated in a panel unit, a signal converting unit generating a plurality of pieces of sensing data for determining a touch input from the plurality of changes in capacitance detected by the sensing circuit unit, and an operating unit determining the touch input based on the plurality of pieces of sensing data, wherein the operating unit corrects a coordinate of the touch input by applying a predetermined correction value when it is determined that the coordinate of the touch input is included in an edge region of the panel unit, and sets different correction values according to a touch area of the touch input included in the edge region.

### CROSS-REFERENCE TO RELATED APPLICATIONS

This application claims the priority of Korean Patent Application No. 10-2012-0145566 filed on Dec. 13, 2012, in the Korean Intellectual Property Office, the disclosure of which is incorporated herein by reference.

### BACKGROUND OF THE INVENTION

1. Field of the Invention

The present invention relates to a touch sensing device and a touch sensing method, capable of providing an accurate touch input by determining different correction values for correcting a coordinate of the touch input according to a touch area of the touch input included in an edge region of a panel unit to solve incomplete recognition of an edge touch, when the coordinate of the touch input is included in the edge region of the panel unit.

2. Description of the Related Art

A touch sensing device such as a touchscreen and a touch pad is an input apparatus attached to a display device to provide an intuitive data input method to a user, and recently, a touch sensing device has been applied to various electronic devices such as portable phones, personal digital assistants (PDAs), navigation devices, and the like. In particular, recently, as demand for smart phones has increased, an employment rate of touch screens as touch sensing devices capable of providing various data input methods in a limited form factor is on the rise.

Touch screens employed in portable devices may be classified into a resistive touch screen and a capacitive touch screen according to a method of sensing a touch utilized thereby. Among these, a capacitive touch screen, having advantages in that it has a relatively long lifespan and various data input methods and gestures are easily implementable therewith, has been increasingly applied. In particular, the capacitive touch screen, facilitating implementation of a multi-touch interface relative to the resistive touch screen, is extensively employed in devices such as smart phones, and the like.

The capacitive touch screen includes a plurality of electrodes having a predetermined pattern, and a plurality of nodes in which capacitance is changed by a touch are defined by the plurality of electrodes. The plurality of nodes distributed on a two-dimensional (2D) plane generate a change in self-capacitance or mutual-capacitance according to a touch, and coordinates of a touch may be calculated by applying a weighted average calculation method, or the like, to the change in capacitance generated in the plurality of nodes. Due to characteristics of a panel unit in which the plurality of electrodes are provided to have regular patterns, in the capacitive touchscreen, an error in which the coordinates of a touch input are not accurately sensed in an edge region adjacent to a corner of the panel unit. Generally, such an error occurs when the coordinates sensed by the touchscreen are recognized as being farther inward toward a center of the panel unit than the coordinates of the touch input which the user has actually made.

In order to solve this problem, a method of changing a form of the plurality of electrodes provided in the panel unit is presented in the related art. A touch input sensing error occurring in an edge region may be decreased by reducing widths of respective electrodes adjacent to four corners of the panel unit provided in a quadrangular form by half and positioning an electrode having a width reduced by half to be parallel to the adjacent corner. However, such a method may cause defects in that the number of electrodes may be increased as compared with an electrode configuration of a general panel unit and thus, the number of wire patterns connecting the electrodes and a sensor chip of the touchscreen may be increased, and as a result, forming an overall hardware configuration including an increase in a width of a bezel region may be complicated.

Patent Document 1 relates to a method of determining coordinates of a touch sensing device, and when detected coordinates are included in an edge region, the detected coordinates are corrected by using a change value of dummy capacitance. Patent Document 2 relates to a touchscreen apparatus, and when detected coordinates are included in an edge region, the detected coordinates are corrected by comparing a change in capacitance used for coordinate detection with dummy capacitance. However, in both Patent Document 1 and Patent Document 2, it is not disclosed that correction values are variably determined based on a touch area of the touch input included in the edge region, and as a result, the coordinates of the touch input are corrected.

### RELATED ART DOCUMENT

(Patent Document 1) US 2011/0127092
(Patent Document 2) US 2012/0105366

### SUMMARY OF THE INVENTION

An aspect of the present invention provides a touch sensing device and a touch sensing method, capable of setting a correction value for correcting an error in coordinate of a touch input based on a touch area of the touch input included in an edge region of a panel unit, when a coordinate of the touch input is included in the edge region of the panel unit.

An aspect of the present invention also provides a touch sensing device and a touch sensing method, capable of minimizing a coordinate mismatch between the edge region and other regions and accurately correcting an error in coordinate generated in the edge region, by determining a correction value with consideration of a touch area of the touch input occurring in the edge region, rather than simply uniformly applying a correction value for correcting the error in coordinate to a condition in which the coordinate of the touch input is included in the edge region.

According to an aspect of the present invention, there is provided a touch sensing device, including: a sensing circuit unit detecting a plurality of changes in capacitance generated in a panel unit; a signal converting unit generating a plurality of pieces of sensing data for determining a touch input from the plurality of changes in capacitance detected by the sensing circuit unit; and an operating unit determining the touch input based on the plurality of pieces of sensing data, wherein the operating unit corrects a coordinate of the touch input by applying a predetermined correction value when it is determined that the coordinate of the touch input is included in an edge region of the panel unit, and sets different correction values according to a touch area of the touch input included in the edge region.

The operating unit may correct the coordinate of the touch input included in the edge region to be close to a corner of the panel unit.

The sensing circuit unit may include at least one integration circuit generating a plurality of analog signals by detecting the plurality of changes in capacitance generated in the panel unit.

The operating unit may correct the coordinate of the touch input by applying a higher correction value, as the touch area of the touch input included in the edge region is increased.

The operating unit may correct the coordinate of the touch input by applying a second value as the correction value, when a first value as a correction value corresponding to the touch area of the touch input included in the edge region is equal to or smaller than the second value set as a current correction value, and correct the coordinate of the touch input by updating the correction value to the first value, when the first value is larger than the second value.

When the coordinate of the touch input moves within the edge region, only in a case in which the touch area of the touch input included in the edge region is increased, the operating unit may update the correction value to a value different from the second value.

When the coordinate of the touch input moves within the edge region, in a case in which the touch area of the touch input included in the edge region is decreased, the operating unit may maintain the correction value as the second value.

The operating unit may initialize the correction value, when the coordinate of the touch input deviates from the edge region.

According to another aspect of the present invention, there is provided a touch sensing method, including: detecting changes in capacitance from a panel unit; obtaining a coordinate of a touch input based on the changes in capacitance; determining a correction value for correcting the coordinate of the touch input based on a touch area of the touch input included in the edge region, when the coordinate of the touch input is included in the edge region; and correcting the coordinate of the touch input by applying the correction value.

In the determining of the correction value, the correction value may be determined by comparing a first value as a correction value corresponding to the touch area of the touch input included in the edge region with a second value set as a current correction value.

In the determining of the correction value, the second value may be determined to be the correction value when the first value is equal to or smaller than the second value, and the first value may be determined to be the correction value when the first value is larger than the second value.

In the determining of the correction value, the correction value may be updated to a value different from the second value, only in a case in which the touch area of the touch input included in the edge region is increased, when the coordinate of the touch input moves within the edge region.

In the determining of the correction value, the correction value may be maintained as the second value in a case in which the touch area of the touch input included in the edge region is decreased, when the coordinate of the touch input moves within the edge region.

In the correcting of the coordinate, the coordinate of the touch input may be corrected to be close to a corner of the panel unit by applying the correction value.

In the determining of the correction value, the correction value may be determined to be higher, as the touch area of the touch input included in the edge region is increased.

### BRIEF DESCRIPTION OF THE DRAWINGS

The above and other aspects, features and advantages of the present invention will be more clearly understood from the following detailed description taken in conjunction with the accompanying drawings, in which:

FIG. 1 is a perspective view illustrating an exterior of an electronic device including a touch sensing device according to an embodiment of the present invention;

FIG. 2 is a diagram illustrating a panel unit of a touchscreen included in the touch sensing device according to the embodiment of the present invention;

FIG. 3 is a circuit diagram illustrating a touch sensing device according to an embodiment of the present invention;

FIGS. 4 and 5 are diagrams respectively illustrating an operation of the touch sensing device according to the embodiment of the present invention; and

FIGS. 6 and 7 are flowcharts respectively describing a touch sensing method according to an embodiment of the present invention.

### DETAILED DESCRIPTION OF EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

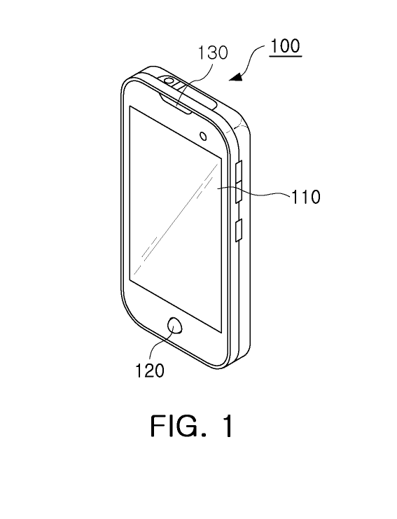

FIG. 1 is a perspective view illustrating an exterior of an electronic device including a touch sensing device according to an embodiment of the present invention.

Referring to FIG. 1, an electronic device 100 according to the embodiment may include a display device 110 for outputting a screen therethrough, an input unit 120, an audio unit 130 for outputting a sound and the like, and may be integrated with the display device 110 to provide the touch sensing device.

As illustrated in FIG. 1, in the case of a mobile device, a touch sensing device is integrated with a display device, and the touch sensing device may have a high degree of light transmittance to allow the screen displayed by the display device to pass therethrough. Accordingly, the touch sensing device may be manufactured by forming a sensing electrode formed of a material such as indium tin oxide (ITO), indium zinc oxide (IZO), zinc oxide (ZnO), carbon nano tube (CNT), or graphene which is transparent and has electrical conductivity on a base substrate formed of a transparent film material such as polyethylene terephthalate (PET), polycarbonate (PC), polyethersulfone (PES), polyimide (PI), or the like. A wiring pattern connected to the sensing electrode formed of a transparent conductive material is formed in a bezel region of the display device. Since the wiring pattern is visually shielded by the bezel region, the wiring pattern may also be formed of a metal such as silver (Ag), copper (Cu), or the like.

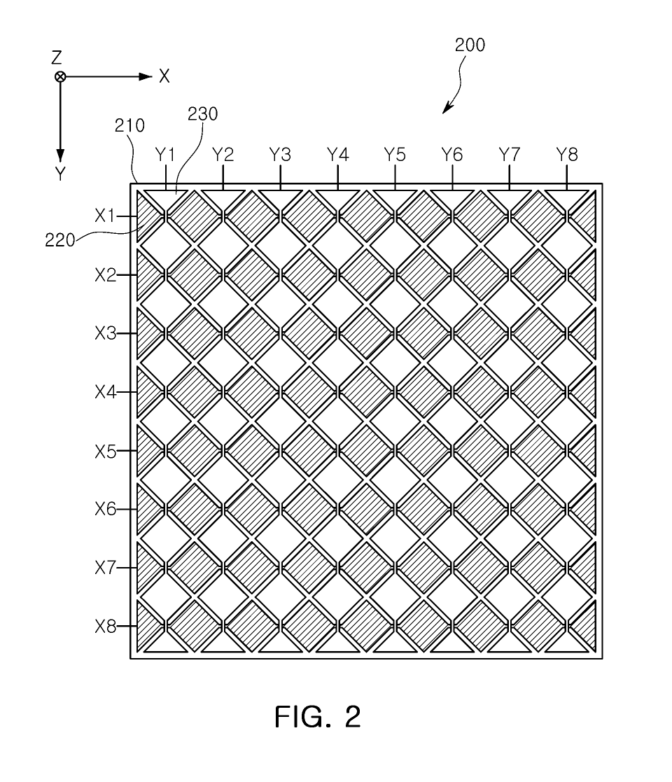

The touch sensing device according to an embodiment of the present invention may be a capacitive type touch sensing device and accordingly, it may include a plurality of electrodes having a predetermined pattern. Also, the touch sensing device according to an embodiment of the present invention may include a capacitance detection circuit detecting changes in capacitance generated in the plurality of electrodes, an analog-to-digital conversion circuit converting an output signal from the capacitance detection circuit into a digital value, an operation circuit determining a touch input by using data converted as the digital value, and the like. Hereinafter, the touch sensing device and an operating method thereof according to the embodiment of the present invention will be described with reference to FIGS. 2 through 7.

FIG. 2 is a diagram illustrating a panel unit of a touchscreen included in the touch sensing device according to the embodiment of the present invention.

Referring to FIG. 2, a touchscreen 200 according to the embodiment of the present invention includes a substrate 210 and a plurality of sensing electrodes 220 and 230 provided on the substrate 210. Although not shown, the plurality of sensing electrodes 220 and 230 may be respectively electrically connected with wiring patterns of a circuit board, which is bonded to one end of the substrate, through wirings and bonding pads. A controller integrated circuit is mounted on the circuit board to detect a sensing signal generated from the plurality of sensing electrodes 220 and 230 and determine a touch input from the sensing signal.

In the case of the touchscreen, the substrate 210 may be a transparent substrate on which the plurality of sensing electrodes 220 and 230 are formed, and may be formed of a plastic material such as polyimide (PI), polymethylmethacrylate (PMMA), polyethyleneterephthalate (PET), polycarbonate (PC), or tempered glass. Further, with respect to a region in which the wirings connected to the plurality of sensing electrodes 220 and 230 are formed, except for a region in which the plurality of sensing electrodes 220 and 230 are formed, a predetermined printing region may be formed on the substrate 210 in order to visually shield the wirings which are generally formed of an opaque metal material.

The plurality of sensing electrodes 220 and 230 may be provided on one surface or both surfaces of the substrate 210. The touchscreen device may be formed of indium tin-oxide (ITO), indium zinc-oxide (IZO), zinc oxide (ZnO), carbon nano tube (CNT), a graphene based material, or the like, having transparency and conductivity. In FIG. 2, the plurality of sensing electrodes 220 and 230 having a diamond-like pattern are illustrated, but the present invention is not limited thereto and the electrodes 220 and 230 may have various polygonal patterns such as a rectangular pattern, a triangular pattern, or the like.

The plurality of sensing electrodes 220 and 230 include first electrodes 220 extending in an X-axis direction and second electrodes 230 extending in a Y-axis direction. The first electrodes 220 and the second electrodes 230 may intersect each other on both surfaces of the substrate 210, or on different substrates 210. In the case in which the first electrodes 220 and the second electrodes 230 are all formed on one surface of the substrate 210, predetermined insulating layers may be partially formed in intersections between the first electrodes 220 and the second electrodes 230.

The touch sensing device, electrically connected to the plurality of sensing electrodes 220 and 230 to sense a touch input, may detect changes in capacitance generated from the plurality of sensing electrodes 220 and 230 according to a touch input applied thereto and sense the touch input therefrom. The first electrodes 220 may be connected to channels D1 to D8 to receive a predetermined driving signal from the controller integrated circuit, and the second electrode 230 may be connected to channels S1 to S8 to allow the touch sensing device to detect a sensing signal. Here, the controller integrated circuit may detect, as a sensing signal, changes in mutual-capacitance generated between the first electrodes 220 and the second electrodes 230, and may be operated in such a manner that driving signals are sequentially applied to the respective first electrodes 220 and the changes in capacitance are simultaneously detected by the second electrodes 230. Namely, when M number of first electrodes 220 and N number of second electrodes 230 are provided, the controller integrated circuit may detect data regarding M×N number of changes in capacitance in order to determine a touch input.

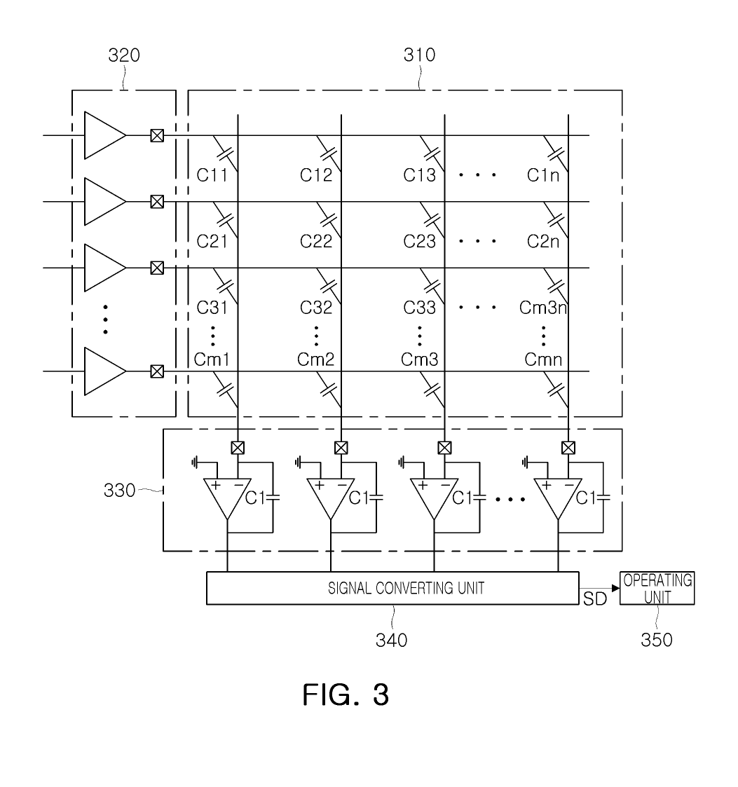

FIG. 3 is a circuit diagram illustrating a touch sensing device according to an embodiment of the present invention.

Referring to FIG. 3, the touch sensing device according to the embodiment of the present invention includes a panel unit 310, a driving circuit unit 320, a sensing circuit unit 330, a signal converting unit 340, an error information generating unit 250, and an operating unit 360. The panel unit 310 includes m number of first electrodes extended in a first axis direction—that is, a horizontal direction in FIG. 3, and n number of second electrodes extended in a second axis direction that intersect with the first axis direction, that is, a vertical direction in FIG. 3. Changes in capacitance C11 to Cmn may be generated in a plurality of nodes in which the first electrodes and second electrodes intersect with each other. The changes in capacitance C11 to Cmn generated in the plurality of nodes may be changes in mutual-capacitance generated according to the driving signals applied to the first electrodes by the driving circuit unit 320. Meanwhile, the driving circuit unit 320, the sensing circuit unit 330, the signal converting unit 340, and the operating unit 350 may be implemented as a single integrated circuit (IC).

The driving circuit unit 320 may apply predetermined driving signals to the first electrodes of the panel unit 310. The driving signals may include a square wave signal, a sine wave signal, a triangle wave signal, and the like, which have a predetermined period and amplitude, and may be sequentially applied to the plurality of first electrodes. FIG. 3 illustrates that circuits for applying driving signals are individually connected to the plurality of the first electrodes. However, alternatively, a single driving signal generating circuit may be provided and driving signals may be applied to the respective first electrodes by using a switching circuit. Further, the driving circuit unit 320 may be operated in a method in which the driving signal are simultaneously applied to all the first electrodes or selectively applied to only a portion of first electrodes to thereby simply detect whether a touch input is present or not.

The sensing circuit unit 330 may include an integration circuit for sensing the changes in capacitance C11 to Cmn generated in the plurality of nodes. The integration circuit may be connected to the plurality of second electrodes. The integration circuit may include at least one operational amplifier and a capacitor C1 having a predetermined capacitance. An inverting input terminal of the at least one operational amplifier is connected to the second electrodes, and thus, the changes in capacitance C11 to Cmn are converted into an analog signal such as a voltage signal or the like to be output. When driving signals are sequentially applied to the plurality of respective first electrodes, since changes in capacitance C11 to Cmn may be simultaneously detected from the second electrodes, the integration circuit may be provided in an amount equal to m number of second electrodes.

The signal converting unit 340 generates a digital signal S_{D} from the analog signal generated by the integration circuit. For example, the signal converting unit 340 may include a time-to-digital converter (TDC) circuit for measuring a period of time for which an analog signal output in the form of voltage from the sensing circuit unit 330 reaches a predetermined reference voltage level and converting the period of time into the digital signal S_{D} or an analog-to-digital converter (ADC) circuit for measuring an amount by which a level of the analog signal output from the sensing circuit unit 330 is changed for a predetermined period of time and converting the amount into the digital signal S_{D}. The operating unit 360 determines a touch input applied to the panel unit 310 by using the digital signal S_{D}. For example, the operating unit 360 may determine the number of touch inputs applied to the panel unit 310, coordinates of the touch input, a gesture based on the touch input, or the like.

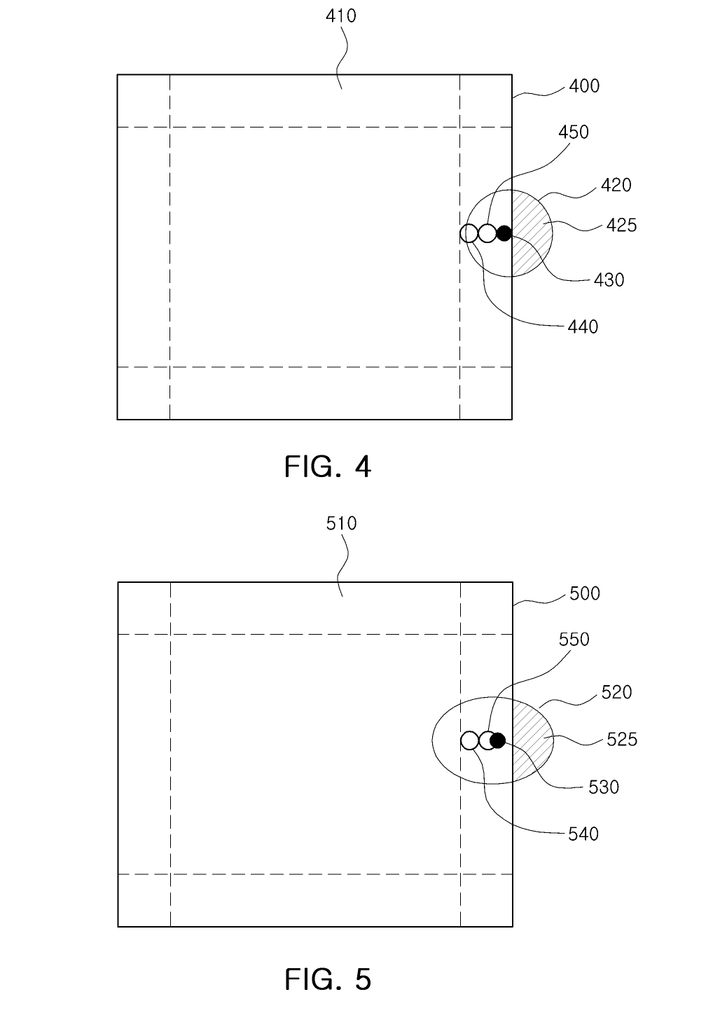

The digital signal S_{D}, the basis for determining the touch input by the operating unit 360, may be data obtained by digitizing the changes in capacitance C11 to Cmn, and particularly, may be data representing differences in capacitance between the case in which the touch input is not generated and the case in which the touch input is generated. In this case, in the case of determining coordinates of touch inputs occurring adjacent to a first row and an m-th row, and a first column and the n-th column which are positioned in corners of the panel unit 310, an error may occur. Hereinafter, an operation for correcting an error in coordinate of the touch input generated in an edge region of the panel unit 31 adjacent to the corners of the panel unit 310 will be described with reference to FIGS. 4 and 5.

FIGS. 4 and 5 are diagrams respectively illustrating an operation of the touch sensing device according to the embodiment of the present invention.

FIG. 4 illustrates a panel unit 400 in a case in which a touch input is applied to the interior of an edge region 410. In the panel unit 400 having a quadrangular shape, the edge region 410 is defined as a portion of a region adjacent to four corners of the panel unit 400. A controller chip connected to the panel unit 400 calculates a center coordinate of a touch input 420 modeled as a circle or an oval, and ideally, needs to detect a coordinate of a first point 430 which a user has intended, in the case in which the touch input 420 is applied to the edge region 410 as illustrated in FIG. 4.

However, when the touch input 420 is applied to the edge region 410, as illustrated in FIG. 4, a partial region of the touch input 420 is recognized as an invalid region 425 that cannot detected by the controller chip through the panel unit 400. Accordingly, the controller chip may only detect a change in capacitance generated in a region except for the invalid region 425 to determine a coordinate of the touch input 420 therefrom. As a result, the coordinate of the touch input 420 determined by the controller chip are represented as a second point 440, rather than the first point 430 which the user actually intended. This is a phenomenon generated by the invalid region 425 included in the touch input 420, and a non-sensing region present in the panel unit 400 generated due to the fact that the sensing electrodes may not be completely adjacent to the corner of the panel unit 400 due to a design of hardware.

Accordingly, ideally, a method of correcting the coordinate of the touch input 420 to be as closer to the corresponding first point 430 as possible. To this end, in the embodiment, when it is determined that the touch input 420 is generated in the edge region 410, a correction value for correcting an error in coordinate of the touch input 420 is set. The correction value may be a predetermined ratio value.

For example, it is assumed that resolution of the panel unit 400 illustrated in FIG. 4 is 800×640, and 40 pixels of the right and the left among 800 pixels in a horizontal direction is set as the edge region 410. In this case, if a horizontal coordinate of the second point 440 calculated by the controller chip according to the touch input 420 is 770 and a correction value for correcting an error in coordinate is 0.5, the error in coordinate may be corrected according to [coordinate after correction=coordinate before correction+(coordinate before correction−reference coordinate)*correction value].

In the embodiment, the coordinate before correction of the touch input 420 is 770, and the reference coordinate may be 760 from which the coordinate starts to be determined as the edge region. Accordingly, the coordinate after correction is acquired as 770+(770-760)*0.5=775. That is, a horizontal coordinate of a third point 450 corresponding to the coordinate after correction is 775 and accordingly, it may be confirmed that the horizontal coordinate is corrected to be closer to the first point 430 which the user has actually intended, than the horizontal coordinate of 770 of the second point 440 before correction.

FIG. 5 illustrates a case in which a touch input 520 having a larger touch area than that of FIG. 4 is applied to an edge region 510. Similarly to the case of FIG. 4, an invalid region 525 as a non-contact region may be generated in the panel unit 500, and accordingly, an error between a coordinate of a first point 530 corresponding to a touch point which the user has intended and a coordinate of a second point 540 detected by the controller chip connected to the panel unit 500 occurs. Accordingly, the controller chip changes the coordinate of the touch input 520 from the second point 540 to a third point 550 by using the similar method to FIG. 4, and as a result, the error may be reduced.

However, in the embodiment illustrated in FIG. 5, a correction value larger than the case of the embodiment of FIG. 4 may be applied. In the case in which the touch input 520 having a large touch area is generated, an error generated in determining the touch input 520 is relatively large. Accordingly, the error may be more accurately corrected by applying a larger correction value than the correction value of 0.5 applied to the embodiment of FIG. 4.

In this case, in order to apply different correction values according to a touch area of the touch input 520, a process of determining the touch area of the touch input 520 may be required. In a capacitive touchscreen, the touch area of the touch input 520 may be determined by the number of nodes in which changes in capacitance are generated by the touch input 520 in the panel unit 500, and a sum of the changes in capacitance generated by corresponding nodes. The touch area of the touch input 520 may depend on distances and resolution of nodes included in the panel unit 500 and sensitivity characteristics thereof in which the change in capacitance is generated.

In FIG. 5, it is assumed that in the panel unit 500 of 800×640 resolution, 40 pixels from respective corners of the panel unit 500 are set as the edge region 510. When the second point 540, the coordinate of the touch input 520 calculated by the controller chip is 765, since the touch input 520 having a larger area than that of FIG. 4 is generated, a correction value larger than 0.5, that is, a correction value of 2.0 may be applied. In this case, a coordinate of the third point 550 after correction is acquired as 765+(765-760)*2.0=775.

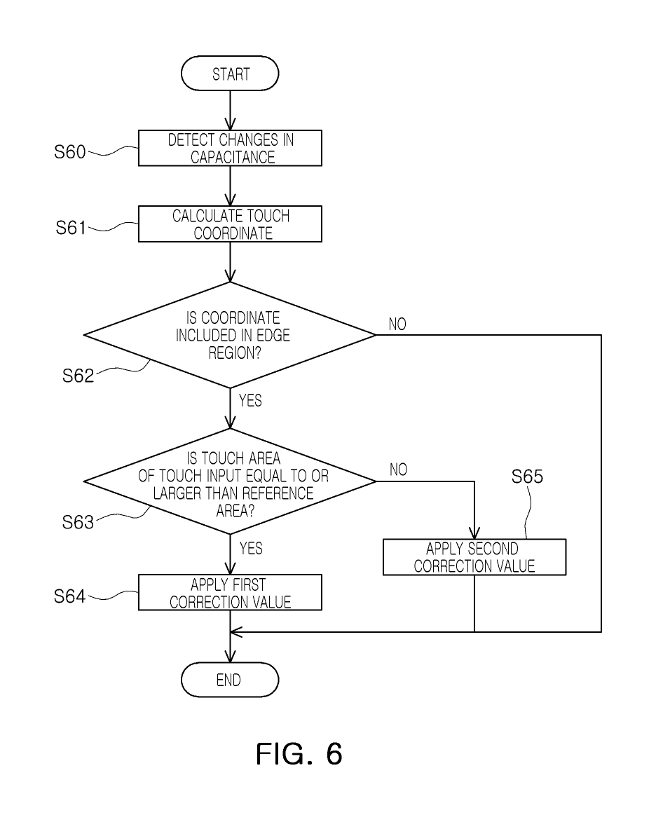

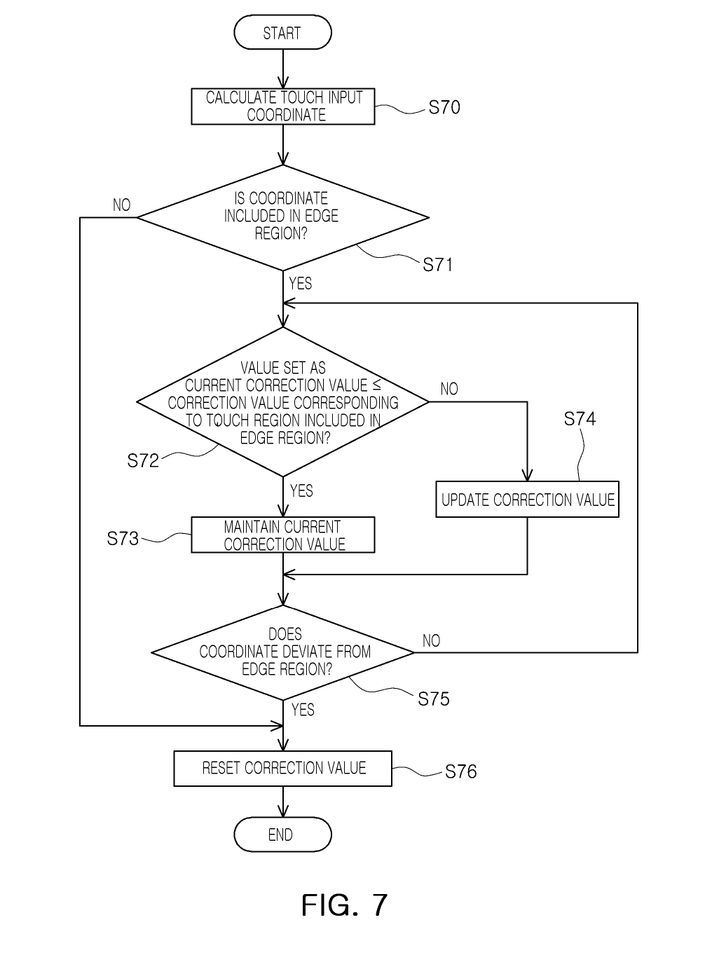

FIGS. 6 and 7 are flowcharts respectively describing a touch sensing method according to an embodiment of the present invention.

Referring to FIG. 6, a touch sensing method according to the embodiment starts to detect changes in capacitance (S60). As described above, the sensing circuit unit 330 including the integration circuit may detect the changes in capacitance and generate a voltage signal having an analog form by detecting the changes in capacitance generated in respective nodes of the panel unit 310. The changes in capacitance detected by the sensing circuit unit 330 are converted into digital data by the signal converting unit 340 to be transferred to the operating unit 350.

The operating unit 350 calculates a coordinate of a touch input (S61). Generally, the operating unit 350 may calculate the coordinate of the touch input by a weighted average method and determine whether the calculated coordinate of the touch input is included in the edge region of the panel unit 300 (S62). The edge region of the panel unit 300 is a portion of the region adjacent to the corners of the panel unit 300, and a width thereof and the like may be pre-defined.

When it is determined that the coordinate of the touch input is not included in the edge region, the operating unit 350 terminates the determination of the coordinate of the touch input without a separate operation. On the other hand, when it is determined that the coordinate of the touch input is included in the edge region, it is determined whether the touch area of the touch input is equal to or larger than a reference area (S63).

As a result of determining the touch area in operation S63, when it is determined that the touch area of the touch input is equal to or larger than the reference area, the operating unit 350 applies a first correction value as a correction value for correcting an error generated due to characteristics of the edge region (S64). On the other hand, when it is determined that the touch area of the touch input is smaller than the reference area, the error of the touch input is corrected by applying a second correction value thereto (S65). Referring to FIGS. 4 and 5, as described above, the first correction value applied when the touch area of the touch input is equal to or larger than the reference area may be larger than the second correction value. This is because the larger the touch area of the touch input, the larger the error when the coordinate of the touch input is determined in the edge region is generated.

Thereafter, referring to FIG. 7, a touch sensing method according to an embodiment starts to calculate a coordinate of a touch input (S70). In order to calculate the coordinate of the touch input, detecting of changes in capacitance and converting the detected capacitance values into digital data may be preceded. Similarly to the case of FIG. 6, the operating unit 350 determines whether the coordinate of the touch input is included in the edge region (S71). When it is determined that the coordinate of the touch input is not included in the edge region, the operating unit 350 terminates the determination of the touch input after resetting or initializing a correction value (S76). The resetting of the correction value will be described below.

As the determined result in operation S71, when it is determined that the coordinate of the touch input is included in the edge region, the operating unit 350 determines whether a current correction value (hereinafter, referred to as a first value for convenience of description) is equal to or smaller than a set correction value set by considering the touch area of the touch input included in the edge region (hereinafter, referred to as a second value for convenience of description) (S72). According to the determined result in operation S72, the correction value may be maintained as the first value (S73) or the correction value may be updated to the second value (S74).

In this case, the first value or the second value applied as the correction value may be selected from among values allocated as correction values for respective sections obtained by classifying touch areas of the touch input. For example, in the case in which the touch areas of the touch input are determined to be 0 to 8, 9 to 11, 12 to 14, and 15 to 17, correction values of 0.5, 0.7, 0.9, and 1.1 are applied, respectively. As the example, different correction values may be applied for respective sections of the touch areas of the touch.

As the determined result in operation S72, when the first value is equal to or smaller than the second value, the operating unit 350 maintains the current connection value as it is (S73). In the case in which there is no problem even when a correction value smaller than the current correction value is applied, that is, in the case in which the touch area of the touch input included in the edge region is decreased, the current correction value is maintained as the first value.

On the other hand, as the determined result in operation S72, when the first value is larger than the second value, the operating unit 350 determines that the touch area of the touch input included in the edge region is increased to thereby update the correction value from the first value to the second value (S74). Finally, in operation S73 and operation S74, only in the case in which the touch area of the touch input included in the edge region is increased, the operating unit 350 updates the correction value to be greater, while the operating unit 350 maintains the set current correction value as it is in the case in which the touch area of the touch input is decreased.

When the correction value is determined based on the touch area of the touch input and the error of the touch input is corrected by applying the determined correction value thereto, the operating unit 350 determines whether the coordinate of the touch input moves and deviates from the edge region (S75). As the determined result in operation S75, when it is determined that the coordinate of the touch input remains in the edge region, the operating unit 350 periodically calculates the touch area of the touch input and determines whether the correction value needs to be changed and applied.

Meanwhile, in operation S75, when it is determined that the coordinate of the touch input deviates from the edge region, since correcting the error of the touch input is not required, the operating unit 350 resets the correction value according to a touch area of the last touch input (S76). The correction value may be initialized to have the smallest value from among correction values allocated for respective sections of the touch areas of the touch input by the operation in operation S76. Accordingly, in the case in which the touch input re-enters the edge region, the operating unit may use the smallest value reset in operation S76 as the correction value and effectively correct the coordinate of the touch input by repeating operation S72 to operation S74 and finding the optimal correction value.

As set forth above, according to embodiments of the invention, a correction value for correcting an error in coordinate is determined by considering a touch area of a touch input included in an edge region, when the coordinate of the touch input is included in the edge region of a panel unit. Therefore, a coordinate recognition error of the touch input generated in the edge region of the panel unit can be accurately corrected, and when the coordinate of the touch input moves from the edge region or to the edge region, a touch error instantaneously generated on a boundary between the edge region and the rest regions can be removed.

While the present invention has been shown and described in connection with the embodiments, it will be apparent to those skilled in the art that modifications and variations can be made without departing from the spirit and scope of the invention as defined by the appended claims.

What is claimed is:

1. A touch sensing device, comprising:
a sensing circuit unit detecting a plurality of changes in capacitance generated in a panel unit;
a signal converting unit generating a plurality of pieces of sensing data for determining a touch input from the plurality of changes in capacitance detected by the sensing circuit unit; and
an operating unit determining the touch input based on the plurality of pieces of sensing data,
wherein the operating unit corrects a coordinate of the touch input by applying a predetermined correction value when it is determined that the coordinate of the touch input is included in an edge region of the panel unit, and sets different correction values according to a touch area of the touch input included in the edge region.

2. The touch sensing device of claim 1, wherein the operating unit corrects the coordinate of the touch input included in the edge region to be close to a corner of the panel unit.

3. The touch sensing device of claim 1, wherein the sensing circuit unit includes at least one integration circuit generating a plurality of analog signals by detecting the plurality of changes in capacitance generated in the panel unit.

4. The touch sensing device of claim 1, wherein the operating unit corrects the coordinate of the touch input by applying a higher correction value, as the touch area of the touch input included in the edge region is increased.

5. The touch sensing device of claim 1, wherein the operating unit corrects the coordinate of the touch input by applying a second value as the correction value, when a first value as a correction value corresponding to the touch area of the touch input included in the edge region is equal to or smaller than the second value set as a current correction value, and corrects the coordinate of the touch input by updating the correction value to the first value, when the first value is larger than the second value.

6. The touch sensing device of claim 5, wherein when the coordinate of the touch input moves within the edge region, only in a case in which the touch area of the touch input included in the edge region is increased, the operating unit updates the correction value to a value different from the second value.

7. The touch sensing device of claim 6, wherein when the coordinate of the touch input moves within the edge region, in a case in which the touch area of the touch input included in the edge region is decreased, the operating unit maintains the correction value as the second value.

8. The touch sensing device of claim 1, wherein the operating unit initializes the correction value, when the coordinate of the touch input deviates from the edge region.

9. A touch sensing method, comprising:
detecting changes in capacitance from a panel unit;
obtaining a coordinate of a touch input based on the changes in capacitance;
determining a correction value for correcting the coordinate of the touch input based on a touch area of the touch input included in the edge region, when the coordinate of the touch input is included in the edge region; and
correcting the coordinate of the touch input by applying the correction value.

10. The touch sensing method of claim 9, wherein in the determining of the correction value, the correction value is determined by comparing a first value as a correction value corresponding to the touch area of the touch input included in the edge region with a second value set as a current correction value.

11. The touch sensing method of claim 10, wherein in the determining of the correction value, the second value is determined to be the correction value when the first value is equal to or smaller than the second value, and the first value is determined to be the correction value when the first value is larger than the second value.

12. The touch sensing method of claim 10, wherein in the determining of the correction value, the correction value is updated to a value different from the second value, only in a case in which the touch area of the touch input included in the edge region is increased, when the coordinate of the touch input moves within the edge region.

13. The touch sensing method of claim 10, wherein in the determining of the correction value, the correction value is maintained as the second value in a case in which the touch area of the touch input included in the edge region is decreased, when the coordinate of the touch input moves within the edge region.

14. The touch sensing method of claim 9, wherein in the correcting of the coordinate, the coordinate of the touch input is corrected to be close to a corner of the panel unit by applying the correction value.

15. The touch sensing method of claim 9, wherein in the determining of the correction value, the correction value is determined to be higher, as the touch area of the touch input included in the edge region is increased.
